(19) United States
(12) Patent Application Publication
(10) Pub. No.: US 2009/0314976 A1
(43) Pub. Date: Dec. 24, 2009

(54) Electromagnetic actuatorä

(76) Inventors: Jochen Tovar, Herzogenaurach (DE); Herbert Stockel, Gräfenberg (DE); Andreas Kufner, Erlangen (DE); Marcus Schiele, Ingolstadt-Ettingen (DE); Alexander Feldmann, München (DE); Claudia Schwarz, Bamberg (DE)

Correspondence Address: HEDMAN & COSTIGAN P.C., 1185 AVENUE OF THE AMERICAS, NEW YORK, NY, 10036, US

(21) Appl. No.: 12/456,655

(22) Filed: Jun. 19, 2009

(30) Foreign Application Priority Data
Jun. 20, 2008 (DE) 10 2008 029 434.9

(51) Int. Cl. F16K 31/02

(52) U.S. Cl. 251/129.15

(57) ABSTRACT

An electromagnetic hydraulic valve (18) comprising an armature (2) which, in the region of its bottom-proximate end position (7) comprises a pressure chamber (9) which serves to damp the movements of the armature (2) and which is relieved from pressure via an annular gap (11) and for enhancing the damping action, the armature (2) further comprises a front-end cavity (36) for receiving hydraulic medium.

### FIELD OF THE INVENTION

The invention concerns an electromagnetic hydraulic valve comprising a cylindrical armature arranged in a hollow cylindrical armature space of a coil housing which is closed on one side by a bottom and pressurized by hydraulic medium, said armature being displaceable through a stroke length H between a bottom-distal end position and a bottom-proximate end position. In a region of the bottom-proximate end position, the armature comprises a pressure chamber which is formed between the bottom and a first front end of the armature facing the bottom and serves to damp movements of the armature, and the armature further comprises an annular gap serving as a choke. For forming the annular gap at least one inner sealing surface is situated within an axial bore arranged in the armature and extending from the first front end towards a second front end of the armature, and at least one outer sealing surface coaxial to the inner sealing surface is arranged on a sealing body which is fixed at least indirectly on the coil housing, and, said pressure chamber, due to a varying height of the annular gap, is formed only within one or more fractional sections ΔH of the stroke H of the armature so that a sum of the fractional sections is given as Σ ΔH<H.

### BACKGROUND OF THE INVENTION

A hydraulic valve of the pre-cited type is disclosed In EP 1 793 149 A2. The proposed hydraulic valve comprises a valve tappet that is actuated by the armature and whose movement in the region of the bottom-proximate end position, i.e. the end position near the bottom of the coil housing is decelerated, so that the impact of the armature on the bottom is damped. This deceleration of the armature referred to as ‘damping’ in the following is realized through a displacement of fluid out of a pressure chamber via a choking annular gap, said pressure chamber being defined in the region of the bottom-proximate end position by the bottom and by a first front end of the armature facing the bottom. The annular gap is formed by an overlapping of an inner sealing surface arranged within an axial bore of the armature with a coaxial outer sealing surface disposed on a sealing body fixed to the coil housing.

For adjusting the damping characteristic of the armature, the radial width and, above all, the variation of height of the annular gap achieved through the stroke of the armature constitute the choking parameters. Both the pattern of variation of the annular gap height and its position relative to the respective end position offer substantially independent degrees of freedom for optimizing the course of movement of the armature.

Tests carried out by the applicant with such a hydraulic valve have shown that the aforesaid degrees of freedom can still be inadequate for assuring the desired damping characteristic of the armature and, thus also, of the valve tappet.

### OBJECTS OF THE INVENTION

It is an object of the invention to provide a hydraulic valve of the pre-cited type possessing an improved damping characteristic of the armature in the region of the bottom-proximate end position, as far as possible, without additional costs.

This and other objects and advantages of the invention will become obvious from the following detailed description.

### SUMMARY OF THE INVENTION

The invention achieves the above objects by the fact that a cavity for receiving hydraulic medium extends outside of the axial bore on the first front end of the armature.

The hydraulic medium flowing into the armature space and collecting in the cavity gets mixed during deceleration and/or upon impact of the armature on the bottom with the air in the pressure chamber and thus forms a gas-liquid mixture with a clearly higher liquid content compared to the hydraulic valve proposed in the pre-cited prior art. The relatively high viscosity of this mixture acts on the one hand as a damping intermediate layer between the bottom and the first front end of the armature that strikes against this bottom and leads, on the other hand, to an enhanced choking and, consequently, damping effect during displacement of the mixture via the annular gap out of the pressure chamber. In order to maximize this effect, the hydraulic valve must ideally be installed exactly in gravity direction with the armature space pointing upwards because it is only then that the largest possible volume of hydraulic medium is situated in the cavity.

According to a further development of the invention, the pressure chamber should act only in the region of the bottom-proximate end position of the armature, the inner sealing surface should be spaced from the outer sealing surface in the bottom-distal end position of the armature by a damping-free stroke section H₀, the inner sealing surface should have a height ‘a’ and the outer sealing surface a height ‘d’ for complying with the equation: a ≧H−H₀ and d≧H−H₀.

As will become clear from the description of examples of embodiment of the invention, this geometric design of the hydraulic valve leads to a continuously increasing height of the annular gap with a correspondingly increasing degree of damping of the armature whose movement in the bottom-proximate end position is damped by the pressure chamber acting only in the region of this position.

In an embodiment of the invention preferred from the manufacturing point of view, the cavity should be configured as a continuous circumferential groove and should particularly extend concentric to the axial bore. Alternatively, however, it is also possible to make a plurality of separate depressions, such as, for example, bores extending parallel to the axial bore.

### BRIEF DESCRIPTION OF THE DRAWINGS

Further features of the invention result from the following description and the appended drawings in which the invention is illustrated in principle and also with reference to an example of embodiment, identical or functionally identical components being identified by the same reference numerals. The figures show:

FIG. 1, an actuator of an electromagnetic hydraulic valve comprising a pressure chamber configured as an overpressure chamber, in an elementary representation;

FIG. 2, an actuator of an electromagnetic hydraulic valve comprising a pressure chamber configured as a partial vacuum chamber, in an elementary representation;

FIG. 3, a diagram in which the height of the annular gap is plotted against the stroke of the armature:

FIG. 4, an electromagnetic hydraulic valve in a longitudinal sectional view and

FIG. 5, the detail X out of FIG. 4 in an enlarged representation.

### DETAILED DESCRIPTION OF THE DRAWINGS

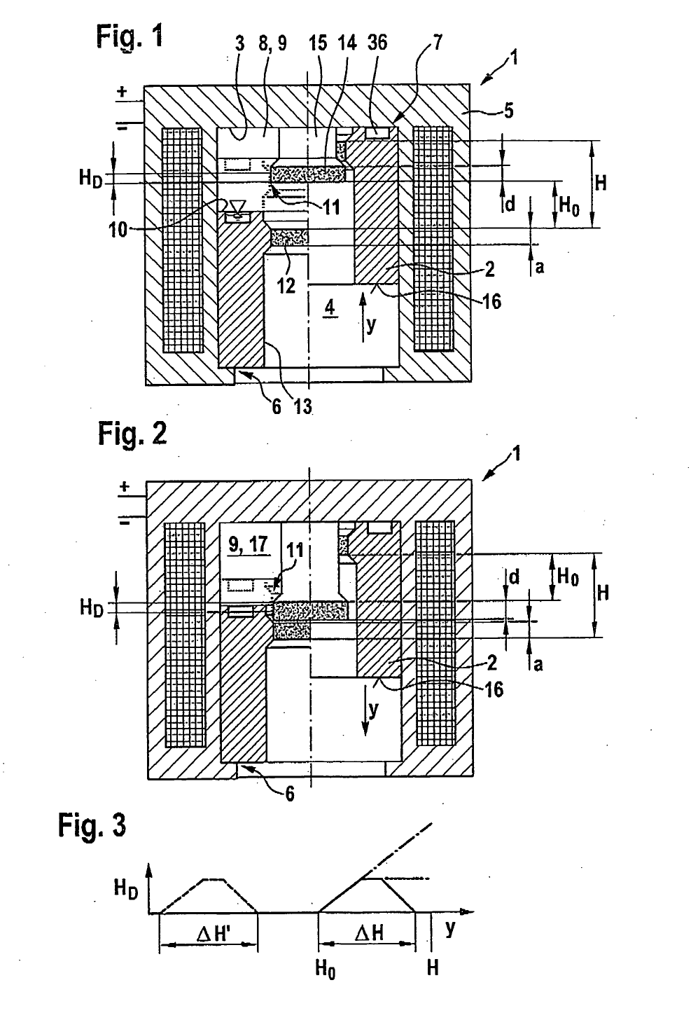

FIG. 1 shows an actuator 1 of an electromagnetic hydraulic valve comprising a cylindrical armature 2 that is mounted for sliding between two end positions spaced apart by a stroke length H in a hollow cylindrical armature space 4 closed on one side by a bottom 3 of a coil housing 5 of the actuator 1. For this figure and the other figures described below, the end position further away from the bottom 3, briefly bottom-distal end position, as shown on the left of the center line of the actuator 1, is identified at 6, while the end position near the bottom, briefly bottom-proximate end position, as shown on the right of the center line, is identified at 7 in the following.

During a movement of the armature 2 in direction of the bottom-proximate end position 7, a pressure chamber configured as an overpressure chamber 8 is enclosed in the region of this end position 7. As can be seen from the intermediate position of the armature represented with a dotted line on the left of the center line, the pressure chamber 9 is defined on one side by the bottom 3 and on another side by a first front end 10 of the armature 2 facing the bottom 3 as also by an annular gap 11. The annular gap 11 is formed by an inner sealing surface 12 arranged inside an axial bore 13 extending in the armature 2 and by an outer sealing surface 14 arranged coaxial to the inner sealing surface 14 on a sealing body 15 which extends from the bottom 3 and is fixed on the coil housing 5. The damping of the movement of the armature 2 is based on the pressurization of the gas-fluid mixture situated in the pressure chamber 9, which mixture, after overcoming a choking resistance, is displaced in direction of a second front end 16 of the armature 2 turned away from the bottom 3. However, because the armature 2 and the sealing body 15 move relative to each other during the stroke H of the armature 2 and because, in the bottom-distal end position 6 of the armature 2, the inner sealing surface 12 is spaced from the outer sealing surface 14 at a distance equal to a damping-free stroke section H₀, it is possible, in conjunction with a varying height H_{D} of the annular gap 11, to realize a damping characteristic consistent with the stroke coordinate y. Important parameters for this, in addition to the damping-free stroke section H₀, a height ‘a’ of the inner sealing surface 12 and a height ‘d’ of the outer sealing surface 14.

Referring at the same time to FIG. 3 in which the height H_{D} of the annular gap 11 is plotted against the stroke coordinate y, it is possible to set damping characteristics as described in the following. Starting from the bottom-distal end position 6, the height H_{D} of the annular gap 11 increases after the stroke section H₀ has been reached. The shape of the next portion of the curve of the height H_{D}, which, in addition to the radial width of the annular gap 11 is determinative for the degree of damping, depends on the height ‘a’ of the inner sealing surface 12 and on the height ‘d’ of the outer sealing surface 14. Insofar as these sealing surfaces 12 and 14 are dimensioned according to FIG. 1, the curve of the height H_{D} shown as a continuous line in FIG. 3 is obtained during a fractional section ΔH of the stroke H in the region of the bottom-proximate end position 7. The length of the fractional section ΔH corresponds in this case to the sum of the height ‘a’ of the inner sealing surface 12 and the height ‘d’ of the outer sealing surface 14 and is chosen such that, immediately before the bottom-proximate end position 7 of the armature 2 is reached, the sealing surfaces 12 and 14 no longer overlap each other. As a result, the movement of the armature 2, as well, shortly before the bottom-proximate end position 7 is reached, is again free of damping because the pressure chamber 9 by reason of the fact that the annular gap 11 no longer exists, can relieve rapidly.

The dotted curve of the height H_{D} of the annular gap 11 shown in FIG. 3 is obtained if either the height ‘a’ or the height ‘d’ is larger than or equal to the difference between the stroke H and the stroke section H₀. Such dimensioning of the heights ‘a’ and ‘d’ thus leads to a first alternative damping characteristic whose degree of damping, after an increase, remains constant In contrast, the chain-dotted curve of the height H_{D} of the annular gap 11 would be obtained if both the height ‘a’ and the height ‘d’ are larger than or equal to the difference between the stroke H and the stroke section H₀. In the case of this second alternative damping characteristic, the degree of damping increases continuously with the height H_{D} of the annular gap 11. Besides this, in both these alternatives, the damping of the movement of the armature 2 is effective till the bottom-proximate end position 7 is finally reached.

In contrast to the example of embodiment shown in FIG. 1, the pressure chamber 9 of the actuator 1 of FIG. 2 acts as a partial vacuum chamber 17 during the movement of the armature 2 in direction of the bottom-distal end position 6. In this case, too, the movement of the armature 2 is damped after the damping-free stroke section H₀ by formation of the annular gap 11 with the height H_{D} that is obtained in the intermediate position of the armature 2 shown as a dotted line. However, the damping of movement in this case is based on the partial vacuum produced in the pressure chamber 9, so that, for pressure equalization, fluid, i.e. gas and/or liquid coming from the direction of the second front end 16 of the armature, now flows through the annular gap 11 into the pressure chamber 9 after overcoming the choking resistance.

In analogy to the embodiments concerning FIG. 1, here too, the damping characteristic can be adjusted through the configuration of the inner sealing surface 12 and the outer sealing surface 14. Besides this, the damping characteristics described for FIG. 1 and FIG. 2 can be combined, so that the movement of the armature 2 is damped both in the bottom-proximate end position 7 and in the bottom-distal end position 6. This can be achieved, for instance, by enlarging the sealing body of FIG. 2 by the outer sealing surface 14 of FIG. 1. With this combination, the curve of the height H_{D} of the annular gap 11 shown in FIG. 3 would be enlarged by the stroke section ΔH′, indicated in broken lines in FIG. 3, in the case of FIG. 1, in the region of the bottom-distal end position 6 and in the case of FIG. 2, in the region of the bottom-proximate end position 7.

From FIG. 3 it is also clear that for all three aforesaid damping regions of the armature 2, i.e. damping only in the bottom-proximate end position 7, damping only in the bottom-distal end position 6 or damping in both end positions 6, 7 the sum of all the stroke sections is always given as Σ ΔH<H.

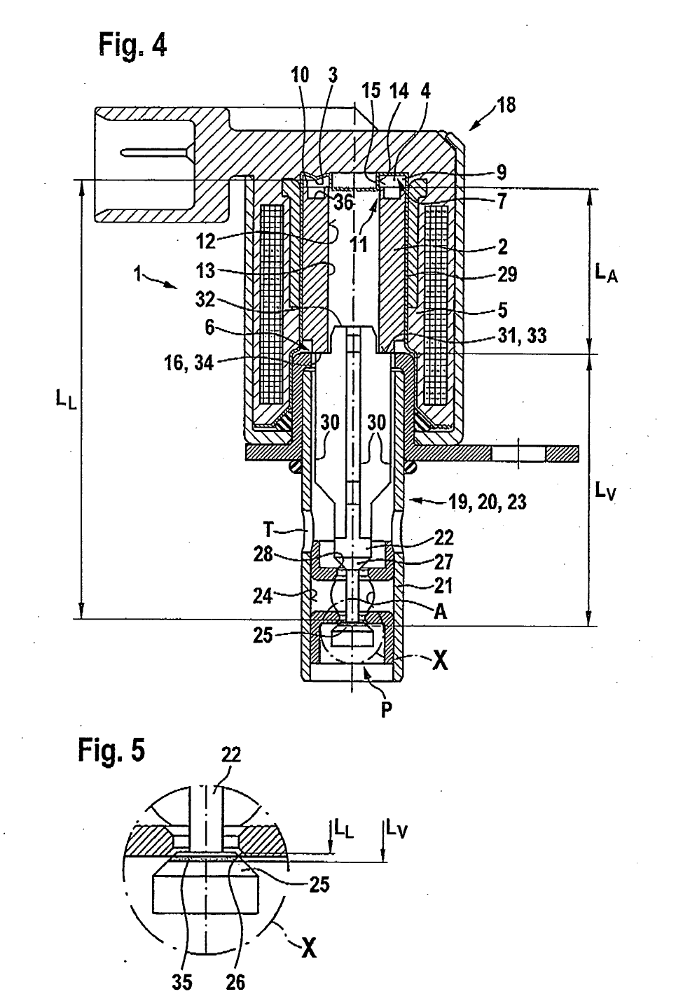

An electromagnetic hydraulic valve 18 disclosed in FIG. 4 comprises the actuator 18 and a control valve 20 configured as a seat valve 19, wherein the movement of the armature 2, based on the principle represented in FIG. 1, is damped in the region of the bottom-proximate end position 7. What is shown is a hollow cylindrical valve housing 21 connected to the coil housing 5, in which valve housing 21, a valve tappet 22 actuated by the armature 2 controls the connection between the hydraulic medium ports configured in the valve housing 21. These ports of the control valve 20, which is configured as a 3/2 directional switching valve and is suitable for actuating hydraulically displaceable adjusting elements of a variable valve train of an internal combustion engine, are a pressure take-off port P arranged in a front end of the valve housing 21 and, extending radially through a side wall 24 of the valve housing 21, a working port A and a tank port T.

As also disclosed in the detail X illustrated in FIG. 5, the connection between the pressure ports P and A is controlled through a first closing body 25 that has a conical configuration and corresponds to a first sealing seat 26 arranged in the valve housing 21. This sealing seat 26 serves as an axial stop for the first closing body 25, so that the stroke of the first closing body 25, and also that of the valve tappet 22 firmly connected to the first closing body 25, is limited in direction of the bottom-proximate end position 7 of the armature 2 by the first sealing seat 26. The connection between the pressure ports A and T is controlled through a second closing body 27 which corresponds to a second sealing seat 28.

The armature space 4 is defined by a bushing 29 made of a non-magnetic material that lines the coil housing 5 and forms the bottom 3. This bushing 29 shields the armature 2 mounted for sliding in the bushing 29 from interfering electromagnetic forces. The sealing body 15 extending from the bottom 3 and .comprising the outer sealing surface 14 is made in one piece with the bushing 29 by a deep drawing method.

The valve tappet 22 is a shaped part made of plastic and comprises axial guide ribs 30 which center the valve tappet 22 radially in the valve housing 21 and bear through axial shoulders 31 merging into a centering peg 32 float-mounted in the continuous axial bore 13 of the tube-shaped armature 2, against the second front end 16 of the armature 2. The axial shoulders 31 serve as a force-transmitting surface 33 of the valve tappet 22, and the second front end 16 serves as a force-transmitting surface 34 of the armature 2 which is in a loose pressure connection with the valve tappet 22 in traction force direction. A relationship between a distance L_{V}, a distance L_{A}, and a distance L_{L} is given as: L_{L}>(L_{V}+L_{A}), wherein
L_{L} is the distance between a sealing surface 35 of the first closing body 25 bearing against the first sealing seat 26 and the force-transmitting surface 33 of the valve tappet 22;
L_{A} is the distance between the force-transmitting surface 34 of the armature and the first front end 10 of the armature, and
L_{L} is the distance between the first sealing seat 26 and the bottom 3.

This distance and component length relationship takes into account unavoidable component length tolerances and guarantees that the sealing surface 35 of the first closing body 25 always bears completely against the first sealing seat 26 before the armature 2 reaches the upper end position 7 after an idle stroke. The idle stroke results from the difference L_{L}−(L_{V}+L_{A}) and is identical to the distance between the force-transmitting surface 33 of the valve tappet 22 and the force-transmitting surface 34 of the armature 2 when the sealing surface 35 of the first closing body 25 bears against the first sealing seat 26 and the armature 2 bears against the bottom 3.

In the case of the hydraulic valve 18 disclosed herein, the movement of the armature 2 and the valve tappet 22 from the bottom-distal end position 6 in direction of the bottom-proximate end position 7 is effected solely through the pressure force prevailing on the front-end pressure take-off port P and acting on the valve tappet 22. In the case of a non-damped armature there would be a risk of the armature rebounding on the bottom 3 in the bottom-proximate end position 7 and striking anew against the valve tappet 22, so that the first closing body 25 would be excited into vibrations relative to the first sealing seat 26. Such vibrations can last for a relatively long time and lead to the aforesaid disturbing effects with regard to the development of pressure in the hydraulic system to be controlled by the hydraulic valve. In particular, the repeatedly established connection between the pressure take-off port P and the work port A can lead to a creeping pressure decrease at the work port A which would impair the displacement dynamics of the adjusting elements of the valve train considerably with the consequence of faulty positioning of the hydraulically displaceable adjusting elements of the valve train.

This is prevented by the damping characteristic of the hydraulic valve 18 described below. The annular gap 11 defining the pressure chamber 9 is formed by the inner sealing surface 12 of the axial bore 13 and the outer sealing surface 14 of the sealing body 15 only when the sealing surface 35 of the first closing body 25 of the valve tappet 22 already bears against the first sealing seat 26. Thus, the fractional section ΔH, in which the damping of the movement of the armature 2 is realized by a partial displacement of the air-oil mixture situated in the pressure chamber 9 through the annular gap 11, lies completely within the idle stroke L_{L}−(L_{V}+L_{A}), so that the equation ΔH≦L_{L}−(L_{V}+L_{A}) applies. Simultaneously, the height H_{D} of the annular gap 11 increases continuously during the fractional section ΔH in keeping with the chain-dotted curve shown in FIG. 3 (referred to above as second alternative damping characteristic), so that the armature 2 is decelerated with a correspondingly increasing damping till it finally reaches the bottom-proximate end position 7.

Following this, the armature 2 can slide back to the valve tappet 22 under the action of gravity and set down relatively softly on the axial shoulders 31 of the axial guide ribs 30. Because the inner sealing surface 12 of the axial bore 13 and the outer sealing surface 14 of the sealing body 15 do not overlap each other in this position, the damping of the movement of the armature 2 is also only effective outside of the stroke range of the valve tappet 22. In this way, the dynamics of the hydraulic valve 18, too, i.e. the switching time of the valve tappet 22, is impaired neither during the closing process nor during the opening process when the connection between the pressure take-off port P and the work port A is closed or opened, and is comparable with the dynamics of a hydraulic valve with a non-damped armature.

An important feature of the present invention is constituted by a cavity which extends on the first front end 10 of the armature 2 outside of the axial bore 13 and is configured in the present example as a circumferential groove concentric to the axial bore 13. The cavity identified at 36 serves to receive hydraulic medium that flows into the armature space 4 and, as shown in FIG. 1 on the left of the center line, collects in the cavity 36. Due to the inertia forces that act on the hydraulic medium before and/or during the impact of the armature 2 against the bottom 3 of the armature space 4, the hydraulic medium is centrifuged out of the cavity 36 and mixes with the air in the pressure chamber 9 thus forming an air-oil mixture with a high oil content. The relatively high viscosity of this mixture acts on the one hand as a damping intermediate layer between the bottom 3 and the first front end 10 of the armature 2 that strikes against the bottom 3 and, on the other hand, it leads to an enhanced choking and, thus also, damping effect during displacement of the mixture out of the pressure chamber 9.

1. An electromagnetic hydraulic valve comprising a cylindrical armature arranged in a hollow cylindrical armature space of a coil housing which is closed on one side by a bottom and pressurized by hydraulic medium, said armature being displaceable through a stroke length H between a bottom-distal end position and a bottom-proximate end position, said armature comprising in a region of the bottom-proximate end position, a pressure chamber, which is formed between the bottom and a first front end (10) of the armature facing the bottom, and serves to damp movements of the armature, and the armature further comprising an annular gap serving as a choke, for forming the annular gap at least one inner sealing surface being situated within an axial bore arranged in the armature and extending from the first front end towards a second front end of the armature, and at least one outer sealing surface coaxial to the inner sealing surface being arranged on a sealing body fixed at least indirectly on the coil housing, and, said pressure chamber, due to a varying height (H_{D}) of the annular gap, being formed only within one or more fractional sections ΔH of the stroke H of the armature, so that a sum of the fractional sections is given as Σ ΔH<H, characterized in that a cavity for receiving hydraulic medium extends outside of the axial bore on the first front end of the armature.

2. A hydraulic valve of claim 1, wherein the pressure chamber acts only in the region of the bottom-proximate end position of the armature, the inner sealing surface is spaced from the outer sealing surface in the bottom-distal end position of the armature by a damping-free stroke section H₀, the inner sealing surface has a height ‘a’ and the outer sealing surface has a height ‘d’, so that following relationships are established: a≧H−H₀.

3. A hydraulic valve of claim 1, wherein the cavity is configured as a continuous circumferential groove.

4. A hydraulic valve of claim 3, wherein the groove extends concentric to the axial bore.
